(19) United States
(12) Patent Application Publication
(10) Pub. No.: US 2025/0085055 A1
(43) Pub. Date: Mar. 13, 2025

(54) REFLOW OVEN

(71) Applicant: Illinois Tool Works Inc., Glenview, IL (US)

(72) Inventors: Yuwei WANG, Suzhou, Jiangsu (CN); De WEI, Suzhou, Jiangsu (CN)

(21) Appl. No.: 18/292,671

(22) PCT Filed: Jul. 26, 2022
(86) PCT No.: PCT/US2022/038369

§ 371 Date: Jan. 26, 2024

(30) Foreign Application Priority Data
Jul. 30, 2021 (CN) 202110871516.3

(51) Int. Cl. F27B 9/30; B23K 3/04; F27D 99/00

(52) U.S. Cl. CPC F27B 9/30; B23K 3/04; F27D 99/0075

(57) ABSTRACT

A reflow oven is disclosed in the present application, the reflow oven including: a housing, where the housing defines an oven chamber, and the oven chamber is provided with an inlet end, an outlet end, and a conveying space extending from the inlet end to the outlet end; and at least two blocking boxes, where the at least two blocking boxes are arranged at the inlet end and the outlet end of the oven chamber respectively and configured to block ambient gases from entering the oven chamber. Each blocking box penetrates at least a part of the housing and is inserted into the oven chamber in a direction transverse to an extension direction of the conveying space, and is configured to be removably mounted on the housing in a drawable manner. According to the present application, with sliding mounting structures arranged, the blocking boxes can be removably mounted on the housing in a drawable manner, such that when the blocking boxes need to be cleaned and maintained, the blocking boxes can be easily removed from the housing for cleaning. When the blocking boxes are cleaned, it is unnecessary to remove a plurality of flow deflectors one by one, which facilitates operations.

### FIELD OF THE DISCLOSURE

The present application relates to a reflow oven, and particularly to a reflow oven including blocking boxes.

### BACKGROUND

For a reflow oven using an inert gas as a working gas, if air from the external environment enters an oven chamber of the reflow oven, a concentration of the inert gas in the oven chamber will be changed, which makes it difficult to control the ratio of the inert gas to oxygen and gas temperature in the oven chamber. Therefore, an inlet end and an outlet end of the reflow oven each are provided with blocking boxes. The inert gas delivered into the blocking boxes can block the air from the external environment from entering the oven chamber of the reflow oven by forming a gas curtain.

However, during use of the blocking boxes, gases in the oven chamber of the reflow oven can make contact with the blocking boxes, and then volatile pollutants in the gases can be condensed on internal components of the blocking boxes, which results in a necessity to clean and maintain the blocking boxes frequently.

### SUMMARY OF THE DISCLOSURE

The present application provides a reflow oven, including: a housing, where the housing defines an oven chamber, and the oven chamber is provided with an inlet end, an outlet end, and a conveying space extending from the inlet end to the outlet end; and at least two blocking boxes, where the at least two blocking boxes are arranged at the inlet end and the outlet end of the oven chamber respectively and configured to block ambient gases from entering the oven chamber. Each blocking box penetrates at least a part of the housing and is inserted into the oven chamber in a direction transverse to an extension direction of the conveying space, and is configured to be removably mounted on the housing in a drawable manner.

According to the above, the reflow oven further includes: at least two sliding mounting structures, where the at least two blocking boxes are removably mounted on the housing by means of the at least two sliding mounting structures respectively in a drawable manner, and each of the sliding mounting structures is arranged on an inner side of the housing and an outer side of a corresponding blocking box.

According to the foregoing, the housing includes a front wall and a rear wall that are arranged around the oven chamber, as well as an inlet end wall and an outlet end wall that are located at the inlet end and the outlet end respectively. The housing further includes at least two support walls, the at least two support walls are arranged at inner sides of the inlet end wall and the outlet end wall respectively and define an inlet end cavity and an outlet end cavity with the inlet end wall and the outlet end wall respectively, and the inlet end cavity and the outlet end cavity are configured to accommodate the at least two blocking boxes. The at least two sliding mounting structures include at least four sliding mounting structures, each of the blocking boxes is mounted on the housing by means of the two sliding mounting structures, and the two sliding mounting structures are arranged between a corresponding blocking box and an adjacent support wall as well as an adjacent inlet end wall/outlet end wall respectively.

According to the foregoing, each of the sliding mounting structures includes a sliding groove and a flange, wherein the sliding groove is provided on the support wall, the inlet end wall or the outlet end wall, the flange is arranged on the blocking box, and the sliding groove and the flange extend in a direction in which the blocking box is inserted.

According to the foregoing, the front wall is provided with at least two front openings, the at least two blocking boxes are capable of penetrating the at least two front openings respectively and are inserted into the oven chamber, and the at least two blocking boxes are configured such that when the at least two blocking boxes are inserted into the oven chamber, each of the at least two blocking boxes closes a corresponding front opening.

According to the foregoing, the at least two blocking boxes include four blocking boxes, wherein two of the blocking boxes are arranged at the inlet end and located on an upper side and a lower side of the conveying space, and the other two of the blocking boxes are arranged at the outlet end and located on the upper side and the lower side of the conveying space.

According to the foregoing, the blocking box includes: a box body, where the box body is provided with a top box opening and a bottom box wall that are oppositely arranged, a pair of side box walls that are oppositely arranged, and a front box wall and a rear box wall that are oppositely arranged, and further has a gas inlet provided on the front box wall; a mounting plate, where the mounting plate covers the top box opening, and a plurality of first vents are provided on the mounting plate at intervals; a distribution plate, where the distribution plate is arranged between the top box opening and the mounting plate, and the distribution plate comprises a plurality of second vents; and a plurality of flow deflectors where the plurality of flow deflectors are mounted on the mounting plate at intervals and extend from the mounting plate in a direction away from the box body. The blocking box is configured such that a gas is capable of entering the box body through the gas inlet and flowing out through the top box opening, so as to flow along the flow deflectors.

According to the foregoing, the flange of each of the sliding mounting structures are arranged at an outer side of one of the pair of side box walls, and the mounting plate and the distribution plate are connected to the side box walls by means of the flange.

According to the foregoing, the box body further includes an openable window arranged on the rear box wall.

According to the foregoing, the front box wall is sized to be consistent with the front opening.

Other objectives and advantages of the present application will be apparent from the following description of the present application with reference to the accompanying drawings, which facilitates comprehensive understanding of the present application.

### BRIEF DESCRIPTION OF THE DRAWINGS

FIG. 1A is a perspective structural view of a front face of a reflow oven according to an embodiment of the present application;

FIG. 1B is a perspective structural view of a back face of the reflow oven as shown in FIG. 1A;

FIG. 1C is a perspective structural view of the reflow oven as shown in FIG. 1A, with part of a panel cover removed;

FIG. 1D is a partial exploded view of the reflow oven as shown in FIG. 1A, with part of the panel cover removed;

FIG. 1E is a partial cross section view of a blocking box of the reflow oven as shown in FIG. 1A;

FIG. 2A is a perspective structural view of a blocking box of FIG. 1D as seen from above;

FIG. 2B is a perspective structural view of the blocking box of FIG. 1D as seen from below;

FIG. 2C is a partial exploded view of the blocking box of FIG. 2A;

FIG. 2D is another exploded view of the blocking box of FIG. 2A;

FIG. 3A is a perspective diagram of a track of FIG. 1D; and

FIG. 3B is a front view of FIG. 3A.

### DETAILED DESCRIPTION

Particular embodiments of the present application are described below with reference to the accompanying drawings which constitute part of this description. It is to be understood that although the terms indicating directions, such as “front”, “back”, “up”, “down”, “left”, “right”, “top”, “bottom”, “inner”, “outer”, “front face” and “back face” are used in the present application to describe various exemplary structural parts and elements in the present application, these terms used herein are, for facilitating the illustration, only determined based on the exemplary orientations as shown in the accompanying drawings. Since the embodiments disclosed in the present application may be arranged in different directions, these terms indicating directions are merely illustrative and should not be regarded as limiting.

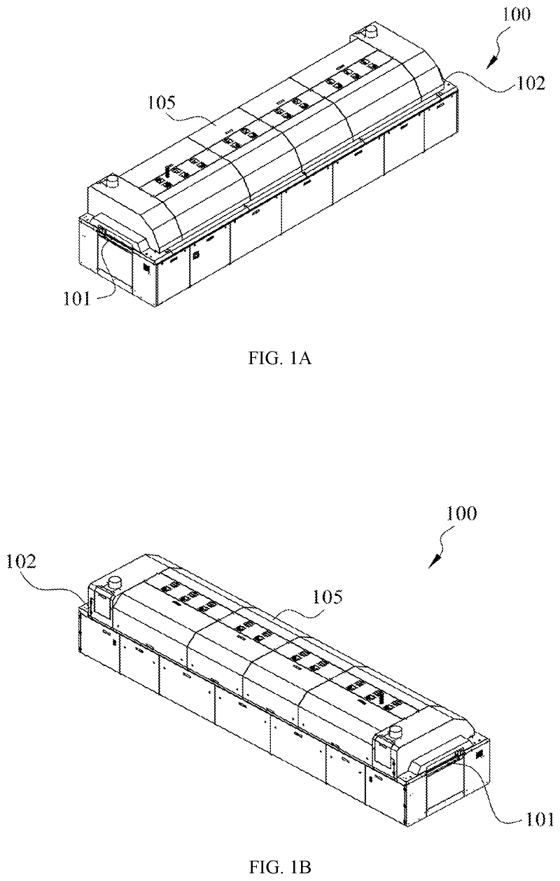

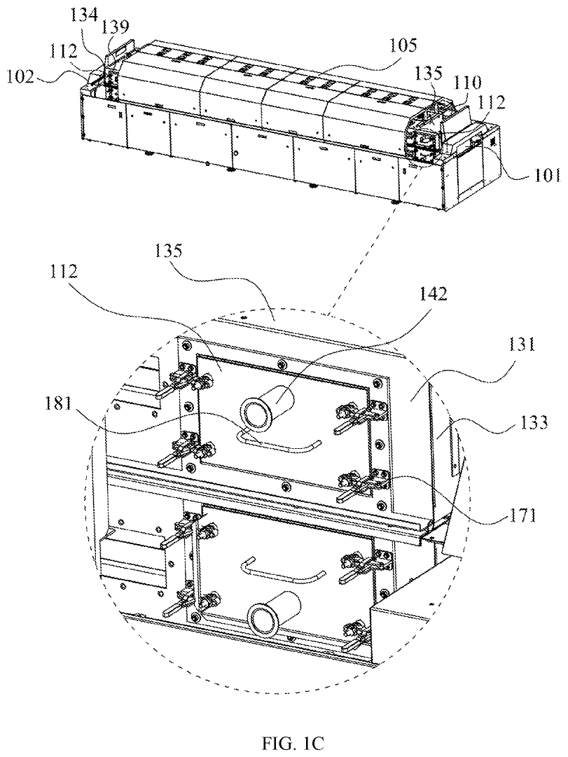

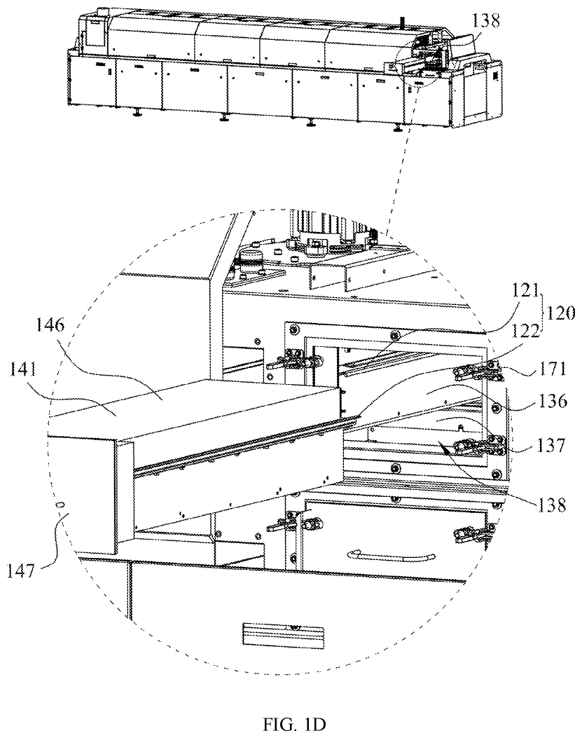

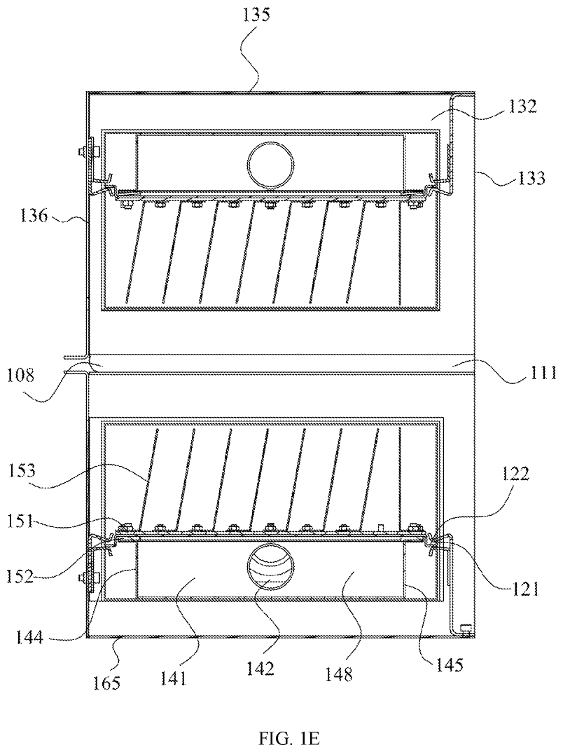

FIGS. 1A-1E are structural schematic diagrams of a reflow oven 100 according to an embodiment of the present application to show a general structure of the reflow oven 100 and positions of blocking boxes 112 in the reflow oven 100. FIGS. 1A and 1B show general structures of a front face and a back face of the reflow oven 100 respectively. FIG. 1C shows the positions of the blocking boxes 112 of the reflow oven 100 with part of a panel cover 105 removed. FIG. 1D shows an exploded view of the blocking boxes 112 of the reflow oven 100 drawn from the reflow oven 100, with part of the panel cover 105 removed. FIG. 1E shows a partial cross section view of the blocking box 112 of the reflow oven 100. Dotted boxes in FIGS. 1C and 1D show partial enlarged views.

As shown in FIGS. 1A-1E, the reflow oven 100 includes a panel cover 105 and a housing 110. The panel cover 105 covers the housing 110. An oven chamber 108 is defined in the housing 110. The oven chamber 108 is provided with an inlet end 101, an outlet end 102, and a conveying space 111 extending from the inlet end 101 to the outlet end 102. The conveying space 111 is configured to accommodate conveying components such as a conveying track, so as to convey a workpiece to be welded into the inlet end 101 through various temperature zones (such as a heating zone, a peak zone and a cooling zone) in the oven chamber 108 to complete a reflow welding process, and then convey the workpiece out of the oven chamber 108 through the outlet end 102. That is, an extension direction of the conveying space 111 is a conveying direction in which a component to be welded is conveyed.

When the reflow oven uses a mixed gas including a large volume of inert gas (such as nitrogen) and a small volume of oxygen as a working gas, it is necessary to continuously feed the inert gas into the oven chamber 108, so as to keep an oxygen concentration in the oven chamber 108 within a certain range. The reflow oven 100 of the present application further includes the blocking boxes 112 arranged at the inlet end 101 and the outlet end 102. The blocking boxes 112 are configured to prevent the oven chamber 108 from communicating with external environment through the inlet end 101 and the outlet end 102. In this way, air in the external environment may be prevented from entering the oven chamber 108 to influence welding quality, and the inert gas may be saved.

In this embodiment, the number of blocking boxes 112 is four. Two of the blocking boxes 112 are arranged on an upper side and a lower side of the conveying space 111 at the inlet end 101. The other two of the blocking boxes 112 are arranged on an upper side and a lower side of the conveying space 111 at the outlet end 102. The two blocking boxes 112 at the inlet end 101 and the two blocking boxes 112 at the outlet end 102 are configured to respectively direct the inert gas to be oppositely conveyed to the conveying space 111, so as to form gas curtains of the inert gas at the inlet end 101 and the outlet end 102, thereby blocking ambient air from entering the oven chamber 108. FIGS. 1C-1E show the blocking boxes 112 at the inlet end 101 in an enlarged manner.

Specifically, the housing 110 is generally cuboid, and includes a top wall 135 and a bottom wall 165 (refer to FIG. 1E, which are not shown in FIG. 1C due to shielding by the panel cover 105) that are oppositely arranged around the oven chamber 108, a front wall 131 and a rear wall 132, as well as an inlet end wall 133 and an outlet end wall 134 that are arranged at the inlet end 101 and the outlet end 102 respectively. The inlet end wall 133 and the outlet end wall 134 are connected to the top wall 135, the bottom wall 165, the front wall 131 and the rear wall 132. The housing 110 further includes two support walls 136 that are arranged inside of the inlet end wall 133 and located on the upper side and the lower side of the conveying space 111, as well as two support walls 136 that are arranged inside of the outlet end wall 134 and located on the upper side and the lower side of the conveying space 111. Each of the support walls 136 is arranged substantially parallel to the inlet end wall 133 and the outlet end wall 134. Two inlet end cavities 137 that are located on the upper side and the lower side of the conveying space 111 and enclosed by one of the top wall 135 or bottom wall 165, the front wall 131, and the rear wall 132 are formed between the two support walls 136 arranged inside of the inlet end wall 133 and the inlet end wall 133. Similarly, two outlet end cavities 139 that are located on the upper side and the lower side of the conveying space 111 are formed between the two support walls 136 arranged inside of the outlet end wall 134 and the outlet end wall 134 (under the condition as shown in FIG. 1B, the outlet end cavities 139 are closed by the blocking boxes 112). The front wall 131 is provided with four front openings 138. Two of the front openings 138 are arranged one above another on one side of the front wall 131 close to the inlet end 101 and are in communication with the inlet end cavities 137. The other two of the front openings 138 are arranged one above another on one side of the front wall 131 close to the outlet end 102 and are in communication with the outlet end cavities 139. The blocking boxes 112 are configured to close corresponding front openings 138 when the blocking boxes 112 are arranged in the oven chamber 108 and are accommodated in the inlet end cavities 137 or the outlet end cavities 139.

The front wall 131 of the housing 110 is further provided with a plurality of latches 171. When the blocking boxes 112 close the front openings 138, the latches 171 may lock the blocking boxes 112 in current positions, so as to prevent the blocking boxes 112 from sliding out of the oven chamber 108 through the front openings 138. The latches 171 may be any locking structure known to those skilled in the art, as long as the latches may block the blocking boxes 112 from sliding forward. Therefore, the latches 171 and the rear wall 132 may together keep the blocking boxes 112 in the inlet end cavities 137 or the outlet end cavities 139 of the oven chamber 108.

Each of the four blocking boxes 112 penetrates one of the front openings 138 on the housing 110 and is arranged in one of the two inlet end cavities 137 and the two outlet end cavities 139, and is removably mounted on the housing 110 in a drawable manner. As an example, the reflow oven 100 further includes eight sliding mounting structures 120. Each of the blocking boxes 112 is removably mounted on the housing 110 by means of two sliding mounting structures 120. Specifically, each sliding mounting structure 120 includes a sliding groove 121 and a flange 122 in slide fit with each other. The flanges 122 are arranged on outer sides of the blocking box 112. The sliding grooves 121 are arranged on inner sides of the support wall 136 and the inlet end wall 133/outlet end wall 134 that are adjacent to the flange 122. The sliding grooves 121 and the flanges 122 extend in a direction transverse to the conveying direction (for example, a front-rear direction) such that each of the blocking boxes 112 may be inserted into the oven chamber 108 in a direction transverse to the conveying direction. In this embodiment, two sliding mounting structures 120 are arranged on left and right sides of the blocking box 112 respectively and extend in the front-rear direction, such that the blocking box 112 may be smoothly drawn in the front-rear direction. In other embodiments, the number of the sliding mounting structures 120 may be also set differently, and the sliding mounting structures may be arranged at other positions in the blocking box 112.

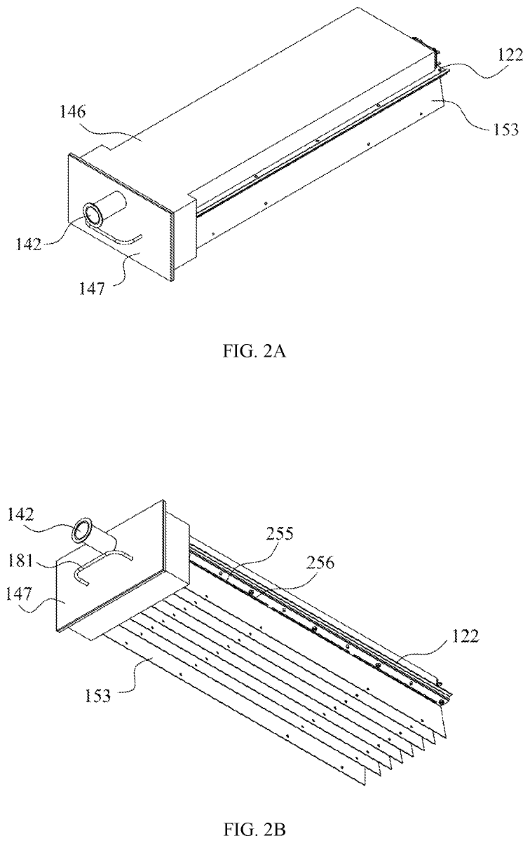

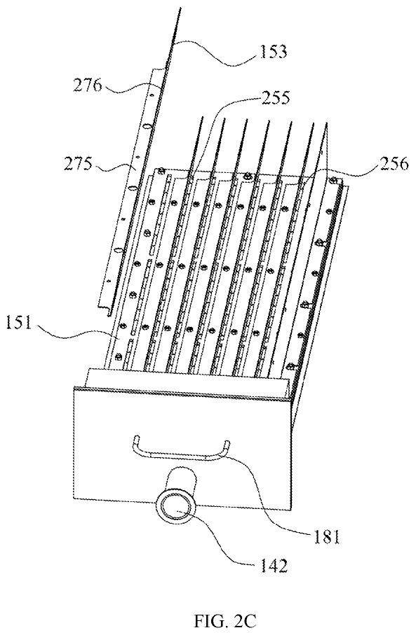

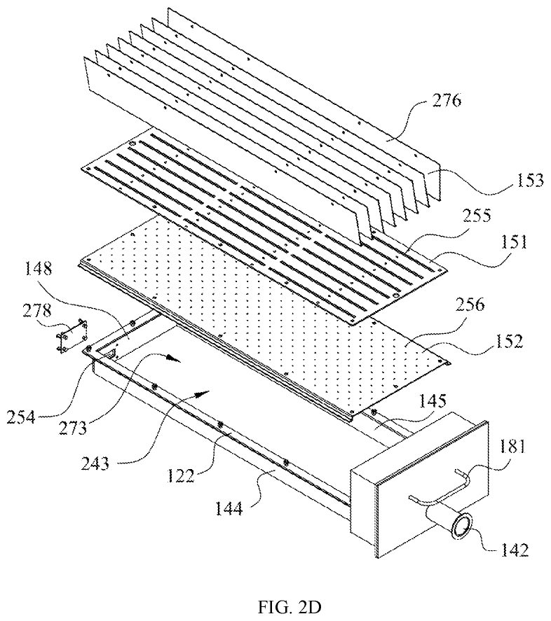

The blocking box 112 includes a square box body 141. The box body 141 has a top box opening (refer to a top box opening 243 in FIG. 2D) and a bottom box wall 146 that are oppositely arranged, a pair of side box walls 144 and 145 that are oppositely arranged, as well as a front box wall 147 and a rear box wall 148 that are oppositely arranged. The front box wall 147 is provided with a gas inlet 142. The inert gas may be delivered into the box body 141 through the gas inlet 142.

The blocking box 112 further includes a mounting plate 151, a distribution plate 152, and a plurality of flow deflectors 153. The inert gas in the box body 141 may flow out through the top box opening 243 and flow along the flow deflectors 153. A specific structure of the blocking box 112 will be described in detail with reference to FIGS. 2A-2D.

With further reference to FIG. 1E, each of the flow deflectors 153 of the blocking boxes 112 on the upper side and the lower side of the conveying space 111 is oppositely extended, such that the inert gas may flow in opposite directions along the flow deflectors 153. That is, the inert gas may flow to the conveying space 111 from the upper side and the lower side of the conveying space 111. In this way, the inert gas may form a gas curtain to block communication between an interior of the oven chamber 108 and gases in the external environment.

FIGS. 2A-2D show a specific structure of the blocking box 112. FIGS. 2A and 2B show perspective views of the blocking box at the upper side of the conveying space 111 as seen from top and bottom respectively, and FIGS. 2C and 2D show two exploded views of the blocking box on the lower side of the conveying space 111. Since the four blocking boxes 112 have the same structures, the blocking box arranged on the lower side of the conveying space 111 will be described in detail as an example. As shown in FIGS. 2A-2D, the box body 141 of the blocking box 112 has a generally square flat shape with an opening, with a lengthwise direction consistent with a direction in which the blocking box is inserted in the oven chamber 108. The box body 141 has an internal cavity 273. The top of the cavity 273 is provided with a top box opening 243. The cavity 273 is in communication with the top box opening 243. The bottom box wall 146 is provided at the bottom of the cavity 273. The front box wall 147, the rear box wall 148, the pair of side box walls 144, 145 and the bottom box wall 146 are arranged around the cavity 273. The front box wall 147 of the box body 141 has a size greater than the size of the rear box wall 148, because the size of the front box wall 147 needs to match that of the front opening 138 of the housing 110 so as to close the front opening 138. The gas inlet 142 is provided on the front box wall 147, and the gas inlet 142 is in communication with the cavity 273, such that the inert gas may enter the cavity 273 through the gas inlet 142 and flow out through the top box opening 243.

The tops of the two side box walls 144 and 145 of the box body 141 are bent outward to form the flanges 122. Two side edges of the distribution plate 152 are connected above the flanges 122 by means of fasteners, such as fastening screws, and cover the top box opening 243 at the top of the box body 141. The distribution plate 152 is uniformly provided with a plurality of vents 256 (i.e., second vents 256). The vents 256 are circular bores. As an example, the vents 256 may be uniformly arranged in columns. In this way, although the gas inlet 142 is provided on a front side in the lengthwise direction of the box body 141, the inert gas flows in the lengthwise direction after entering the cavity 273, and then uniformly flows out through the vents 256 through the distribution plate 152.

Two side edges of the mounting plate 151 are also connected to above edges of the corresponding flanges 122 and the distribution plate 152 by means of fasteners, such as fastening screws, and cover over the top box opening 243 and the distribution plate 152. The mounting plate 151 is configured to mount a plurality of flow deflectors 153. The mounting plate 151 is provided with a plurality of vents 255 (i.e., first vents 255). The vents 255 are strip-shaped bores. The strip-shaped vents 255 are arranged in columns. Positions of each column of vents 255 correspond to those of some of the circular vents 256, such that the inert gas flowing out through the vents 256 may then flow out through the vents 255.

The plurality of flow deflectors 153 are connected to the mounting plate 151 at intervals by means of fasteners, such as fastening screws. The number of the flow deflectors 153 is set to correspond to the number of columns of the vents 255, such that each flow deflector 153 may be mounted at a side of one column of vents 255 or between two adjacent columns of vents 255, but the flow deflector 153 cannot block the vents 255. Specifically, each flow deflector 153 includes a plate part 276 and a bent edge 275, and the plate part 276 extends from the mounting plate 151 in a direction away from the box body 141. The bent edge 275 is bent from a bottom edge of the plate part 276 to one side (for example, a left side in FIG. 2C), and the flow deflector 153 is connected to the mounting plate 151 by means of the bent edge 275. The vents 255 on the mounting plate 151 are immediately adjacent to the other side (for example, a right side in FIG. 2C) of the bottom edge of the plate part 276 of the flow deflector 153. In this way, the inert gas flowing out through the vents 255 may flow along the plate part 276 in a direction away from the box body 141. When the two blocking boxes 112 are oppositely placed on the upper side and the lower side of the conveying space 111, the inert gas flowing along the plate part 276 of each flow deflector 153 may flow in opposite directions to the upper side and the lower side of the conveying space 111.

In this embodiment, the rear box wall 148 is further provided with an openable window 254. When the blocking box 112 operates, the window 254 is closed, such that the inert gas may flow out along the flow deflector 153 in an expected path. When cleaning of the blocking box 112 is required, the window 254 is opened, such that after the blocking box 112 is directly immersed in cleaning liquid, the cleaning liquid may enter the cavity 273 of the box body 141. As a specific example, the window 254 is opened or closed by a cover plate 278.

The front box wall 147 is further provided with a handle 181. The blocking box 112 may be conveniently drawn out from the oven chamber 108 or the blocking box 112 may be conveniently inserted into the oven chamber 108 by means of the handle 181.

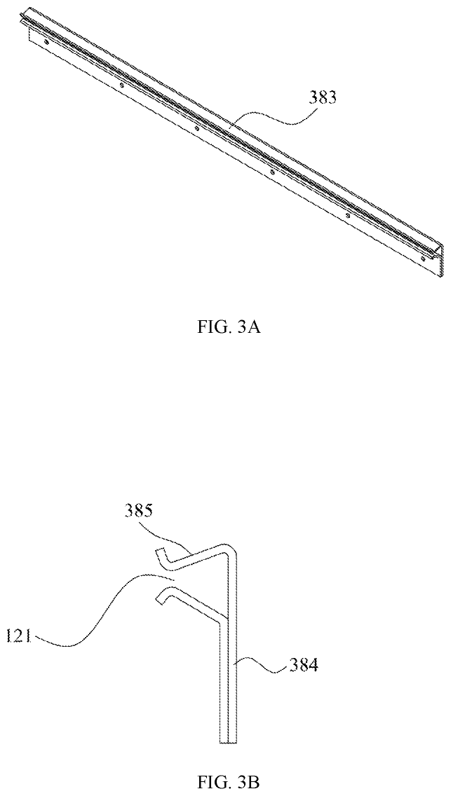

FIGS. 3A and 3B show a structure of an embodiment of a track 383. FIG. 3A shows a perspective structural view of the track 383. FIG. 3B shows a front view of FIG. 3A. As shown in FIGS. 3A and 3B, the track 383 extends in a lengthwise direction. The track 383 includes a connecting part 384 and a receiving part 385. The receiving part 385 is arranged at one side of the top of the connecting part 384. The connecting part 384 is configured to be connected to the support walls 136 or the end walls by means of a plurality of fasteners, such as fastening screws. The receiving part 385 is configured to form the sliding groove 121 extending in a lengthwise direction of the track 383. The sliding groove 121 may cooperate with the flange 122 to form the sliding mounting structure 120.

In some other embodiments, the track 383 may have other shapes, and only needs to include the connecting part for fixedly connecting to the housing 110 and the receiving part for forming the sliding groove 121. It may be understood by those skilled in the art that although the sliding grooves 121 are provided on the inner sides of the support wall 136 and the inlet end wall 133/outlet end wall 134 that are adjacent to corresponding flanges 122, the connecting part of the track may not be connected to the support wall 136 and the inlet end wall 133/outlet end wall 134, but to other parts of the housing 110, such as the top wall 135 or the bottom wall 165.

In some reflow ovens, it is necessary to continuously introduce the inert gas into the oven chamber to ensure welding quality of a circuit board to be welded, so as to control an oxygen concentration in an oven chamber atmosphere within a certain range. Generally, gas pressure in the oven chamber of the reflow oven is low, and the air in the external environment may easily enter the oven chamber, such that the oxygen concentration in the oven chamber may be influenced, which may further influence a welding effect of the circuit board. The blocking boxes are arranged at the inlet end and the outlet end of the oven chamber, such that the ambient gas may be blocked from entering the oven chamber, and the inert gas input from the blocking boxes may be delivered into the oven chamber. When the gas with pollutants in the oven chamber makes contact with the blocking boxes, some pollutants are intended to be condensed on the blocking boxes, which may block the vents, and inhibit the blocking boxes from creating a gas curtain. Therefore, it is necessary to maintain and clean the blocking boxes. In the reflow oven of the present application, with the sliding mounting structure arranged, the blocking boxes may be removably mounted on the housing in a drawable manner, such that when the blocking boxes need to be cleaned and maintained, the blocking boxes may be conveniently removed from the housing for cleaning. When the blocking boxes are cleaned, it is unnecessary to remove the plurality of flow deflectors one by one, but all of the blocking boxes are directly soaked in the cleaning liquid as a whole and cleaned by means of ultrasound, for example. Operations are facilitated, cleaning methods are diverse, and the blocking boxes may be washed cleaner.

Although the present application is described with reference to the specific embodiments shown in the accompanying drawings, it should be understood that the reflow oven of the present application may have many variations without departing from the spirit, scope and background of the teachings of the present application. Those of ordinary skill in the art would also have realized that there are different ways to alter the structures in the embodiments disclosed in the present application, which all fall within the spirit and scope of the present application and the claims.

1. A reflow oven, comprising:
a housing, wherein the housing defines an oven chamber, and the oven chamber is provided with an inlet end, an outlet end, and a conveying space extending from the inlet end to the outlet end; and
at least two blocking boxes, wherein the at least two blocking boxes are arranged at the inlet end and the outlet end of the oven chamber respectively and configured to block ambient gases from entering the oven chamber,
wherein each of the blocking boxes penetrates at least a part of the housing and is inserted into the oven chamber in a direction transverse to an extension direction of the conveying space, and is configured to be removably mounted on the housing in a drawable manner.

2. The reflow oven as claimed in claim 1, further comprising:
at least two sliding mounting structures, wherein the at least two blocking boxes are removably mounted on the housing by means of the at least two sliding mounting structures respectively in a drawable manner, and each of the sliding mounting structures is arranged on an inner side of the housing and an outer side of a corresponding blocking box.

3. The reflow oven as claimed in claim 2, wherein
the housing comprises a front wall and a rear wall that are arranged around the oven chamber, as well as an inlet end wall and an outlet end wall that are located at the inlet end and the outlet end respectively;
the housing further comprises at least two support walls, the at least two support walls are arranged on inner sides of the inlet end wall and the outlet end wall respectively and define an inlet end cavity and an outlet end cavity together with the inlet end wall and the outlet end wall respectively, and the inlet end cavity and the outlet end cavity are configured to accommodate the at least two blocking boxes; and
the at least two sliding mounting structures comprise at least four sliding mounting structures, each of the blocking boxes is mounted on the housing by means of the two sliding mounting structures, and the two sliding mounting structures are arranged between a corresponding blocking box and an adjacent support wall as well as an adjacent inlet end wall/outlet end wall respectively.

4. The reflow oven as claimed in claim 3, wherein
each of the sliding mounting structures comprises a sliding groove and a flange, wherein the sliding groove is provided on the support wall, the inlet end wall or the outlet end wall, the flange is arranged on the blocking box, and the sliding groove and the flange extend in a direction in which the blocking box is inserted.

5. The reflow oven as claimed in claim 4, wherein
the front wall is provided with at least two front openings, the at least two blocking boxes are capable of penetrating the at least two front openings respectively and are inserted into the oven chamber, and the at least two blocking boxes are configured such that when the at least two blocking boxes are inserted into the oven chamber, each of the at least two blocking boxes closes a corresponding front opening.

6. The reflow oven as claimed in claim 5, wherein
the at least two blocking boxes comprise four blocking boxes, wherein two of the blocking boxes are arranged at the inlet end and located on an upper side and a lower side of the conveying space, and the other two of the blocking boxes are arranged at the outlet end and located on the upper side and the lower side of the conveying space.

7. The reflow oven as claimed in claim 6, wherein each of the blocking boxes comprises:
a box body, wherein the box body is provided with a top box opening and a bottom box wall that are oppositely arranged, a pair of side box walls that are oppositely arranged, and a front box wall and a rear box wall that are oppositely arranged, and further has a gas inlet provided on the front box wall;
amounting plate, wherein the mounting plate covers the top box opening, and a plurality of first vents are provided on the mounting plate at intervals;
a distribution plate, wherein the distribution plate is arranged between the top box opening and the mounting plate, and the distribution plate comprises a plurality of second vents; and
a plurality of flow deflectors, wherein the plurality of flow deflectors are mounted on the mounting plate at intervals and extend from the mounting plate in a direction away from the box body,
wherein the blocking box is configured such that a gas is capable of entering the box body through the gas inlet and flowing out through the top box opening, so as to flow along the flow deflectors.

8. The reflow oven as claimed in claim 7, wherein
the flange of each of the sliding mounting structures are arranged at an outer side of one of the pair of side box walls, and the mounting plate and the distribution plate are connected to the side box walls by means of the flange.

9. The reflow oven as claimed in claim 7, wherein
the box body further comprises an openable window arranged on the rear box wall.

10. The reflow oven as claimed in claim 9, wherein
the front box wall is sized to be consistent with the front opening.
